(19) United States
(12) Patent Application Publication
(10) Pub. No.: US 2016/0221846 A1
(43) Pub. Date: Aug. 4, 2016

(54) PROCESS FOR WATER TREATMENT PRIOR TO REVERSE OSMOSIS

(71) Applicant: Veolia Water Technologies, Inc., Moon Township, PA (US)

(72) Inventors: Stanton R. Smith, Belmont, MA (US); Jeremy Cardin, Belmont, MA (US); Benoit Tranape, Somerville, MA (US); Richard Higgins, Reading, MA (US)

(73) Assignee: Veolia Water Technologies, Inc., Moon Township, PA (US)

(21) Appl. No.: 15/090,949

(22) Filed: Apr. 5, 2016

Related U.S. Application Data
(63) Continuation-in-part of application No. 14/205,464, filed on Mar. 12, 2014.
(60) Provisional application No. 61/784,553, filed on Mar. 14, 2013.

(51) Int. Cl. C02F 1/52; C02F 1/44

(52) U.S. Cl. CPC C02F 1/5245; C02F 1/444; C02F 1/441; C02F 2303/18; C02F 2301/046

(57) ABSTRACT

A process for treating feedwater with a microfiltration or ultrafiltration membrane unit and a downstream reverse osmosis unit. An aluminum salt coagulant is added and mixed with the feedwater upstream of a membrane separation unit. An aluminum salt coagulant is added and mixed with the wastewater upstream of the membrane separation unit. The membrane separation unit produces a permeate that is directed to the reverse osmosis membrane. The concentration of aluminum in the permeate is controlled by controlling the hydraulic residence time for aluminum salt reaction products in a concentrate loop associated with the membrane separation unit.

The present application is a continuation-in-part of U.S. patent application Ser. No. 14/205,464 filed Mar. 12, 2014 and claims priority to provisional U.S. Patent Application Ser. No. 61/784,553 filed Mar. 14, 2013. Each of these references are expressly incorporated herein by reference.

### FIELD OF THE INVENTION

The present invention relates to a pre-treatment process for removing aluminum from a feedwater directed to a reverse osmosis unit.

### BACKGROUND OF THE INVENTION

Reverse osmosis (RO) is employed as a key step in production of municipal drinking water and for treatment of various industrial wastewaters to a quality suitable for re-use and/or environmental discharge. Productivity (measured as permeability or pressure-normalized flux) of commercial RO processes is dependent on minimizing concentrations of RO-membrane foulants in the feedwater to the RO process. A common RO-membrane foulant is dissolved aluminum ion, which can be present in the starting water to be treated and/or may be released into RO feedwater by useful pretreatment processes that utilize aluminum salts as coagulants to remove dissolved organics present in the starting water. RO processes require RO feedwater to contain no more than about 0.1 ppm dissolved aluminum to minimize the RO membrane fouling effect by the aluminum ions. Water treatment processes that utilize aluminum salt-based coagulation prior to an RO membrane process operation generally utilize membrane microfiltration or ultrafiltration as a pre-treatment step to remove suspended solids and to coagulate and/or flocculate some fraction of dissolved organics in the process water, such that the permeate from the membrane microfiltration or ultrafiltration process becomes the feedwater to the RO process. For such integrated processes, it has generally been necessary to provide a pH-modifying additive coincident with aluminum salt coagulation in order to ensure that the aluminum concentration in the RO feedwater is maintained below the 0.1 ppm level. Use of the pH-modifying additive adds cost and complexity to the integrated process.

Coagulation and/or flocculation of dissolved and suspended compounds in process streams just prior to membrane microfiltration or ultrafiltration is well-known in the field of water treatment. Water Treatment: Principles and Design, Second Ed. rev. by J. C. Crittenden et al., Wiley & Sons, Hoboken, N.J., 2005, p. 1012. The most commonly employed coagulant and flocculant aids include organic polymeric compounds, iron salts and aluminum salts. Specific choice of coagulant/flocculant for a particular process stream is based on consideration of relative cost, relative effectiveness of effectively coagulating/flocculating compounds in the process stream, and degree of permeability of the captured filter cake on the microfiltration/ultrafiltration membrane surface. For instance, for clarification of tailings pond water derived from oil sands mining, membrane ultrafiltration can be employed, with aluminum sulfate (alum) known to be a preferred coagulant due to high solids removal efficiency. E. S. Kim et al., Sep. Purif. Techn, 81 (2011) 418-428. Similarly, alum coagulation prior to ceramic membrane ultrafiltration is known. K. Guerra et al., Sep. Purif. Techn, 87 (2012) 47-53.s

Additional considerations may be other process effects characteristic of specific coagulants/flocculants, such as relative ease of removal from the membrane surface, and effects on downstream processes. A specific instance of a deleterious effect on a downstream process is the effect of residual aluminum salt solubility on downstream reverse osmosis (RO) membranes, for which dissolved aluminum cations can cause strong fouling of the RO membrane. Hence, for integrated water treatment processes involving coagulation/flocculation combined with membrane microfiltration or ultrafiltration, followed by an RO step to produce high-purity water, generally use of aluminum salts as coagulants would be avoided due to the side-effect of RO membrane fouling. While it is possible to add a pH-modifying additive coincident with, or immediately after, aluminum salt coagulation, this introduces added cost and process complexity. Other practical means of mitigating fouling of RO membranes by dissolved aluminum ions derived from upstream aluminum salt coagulation processes have not been considered in the prior art. The subject of this invention is such a process.

### SUMMARY OF THE INVENTION

In one embodiment, the present invention entails a process for treating feedwater with a microfiltration or ultrafiltration membrane separation unit and a downstream reverse osmosis (RO) unit. A coagulant in the form of an aluminum salt is added to the feedwater upstream of the membrane separation unit. This increases the dissolved aluminum concentration in the feedwater and has the potential to foul membranes of the RO unit. To address this problem, the process in one embodiment, without any significant pH adjustment from additional pH-modifying compound(s), reduces the aluminum concentration in the feed to the RO unit to less than 0.1 ppm by controlling the hydraulic residence time of the coagulated feedwater.

The present invention in one embodiment comprises a method of treating wastewater that employs a reverse osmosis membrane and the method includes reducing the tendency of the reverse osmosis membrane to foul due to the concentration of aluminum in the feed to the reverse osmosis membrane. The method includes mixing an aluminum salt coagulant with the wastewater to be treated. This forms a coagulated wastewater and results in the precipitation of aluminum hydroxide-based precipitants from the coagulated feedwater. After mixing the aluminum salt coagulant with the wastewater, the method includes directing the wastewater into a hydraulic residence time (HRT) control tank. Further, the method includes pumping the coagulated wastewater from the HRT control tank to a membrane separation unit and producing a permeate and a concentrate. At least a portion of the concentrate is recycled back to the HRT control tank. The permeate produced by the membrane separation unit is directed to the reverse osmosis membrane and filtered, which results in the production of an RO permeate and an RO reject. The aluminum concentration of the permeate from the membrane separation unit is controlled and maintained at less than a targeted or threshold concentration by varying the volume or level of the coagulated wastewater in the HRT control tank.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of the process of the present invention.

FIG. 2 is another schematic illustration of a particular embodiment of the present invention.

### DESCRIPTION OF EXEMPLARY EMBODIMENTS

With respect to the drawings, the wastewater treatment process of the present invention is shown therein and indicated generally by the numeral 10. As will be appreciated from subsequent portions of the disclosure, the wastewater treatment process adds an aluminum salt as a coagulant to the wastewater. The purpose of the aluminum salt is to destabilize particles in the wastewater to bring about aggregation and flocculation of these particles. In other words, the coagulant, which in this case is an aluminum salt facilitates the downstream removal of suspended solids and precipitants.

After the aluminum salt coagulant is added and thoroughly mixed with the wastewater, the wastewater is directed to a microfiltration or ultrafiltration membrane separation unit indicated by the numeral 12. Microfiltration or ultrafiltration membrane separation unit can be of various forms. In one embodiment, the membrane separation unit 12 is a ceramic membrane and, more particularly, a ceramic membrane of the cross-flow ultrafiltration type. In one example, the separation layer comprises titanium dioxide and has an average pore size of 0.1 microns. In another example, the separation layer comprises titanium dioxide and has an average pore size of 0.1 microns. As noted above, other types of microfiltration or ultrafiltration membrane separation units can be employed in the wastewater treatment process.

Membrane separation unit 12 produces a permeate stream and a retentate or reject stream. The membrane separation unit 12 is operative to remove substantially all suspended particles and precipitants. Membrane separation unit 12 can be utilized in a wide range of applications to remove suspended solids and precipitants. In particular, membrane separation unit 12 is effective in treating produced water resulting from oil and gas recovery processes. Typically these waste streams include free oil and emulsified oil. A ceramic membrane, for example, is effective to remove both free oil and emulsified oil from the feedwater.

Continuing to refer to the drawings, downstream of the membrane separation unit 12 is a reverse osmosis unit 14. In this process, the reverse osmosis unit 14 is operative to receive the permeate produced by the membrane separation unit or ceramic membrane 12. Reverse osmosis unit 14 produces an RO permeate and an RO reject stream. The reverse osmosis units remove dissolved solids such as total organic carbon, soluble silica and a wide variety of dissolved solids.

As noted above, the process of the present invention entails mixing an aluminum salt coagulant with the wastewater upstream of the membrane separation unit 12 to destabilize particles in the wastewater and promote aggregation and flocculation of these particles. This process conditions the wastewater upstream of the membrane separation unit 12 such that suspended particles and precipitants can be easily removed in the membrane separation unit or ceramic membrane 12.

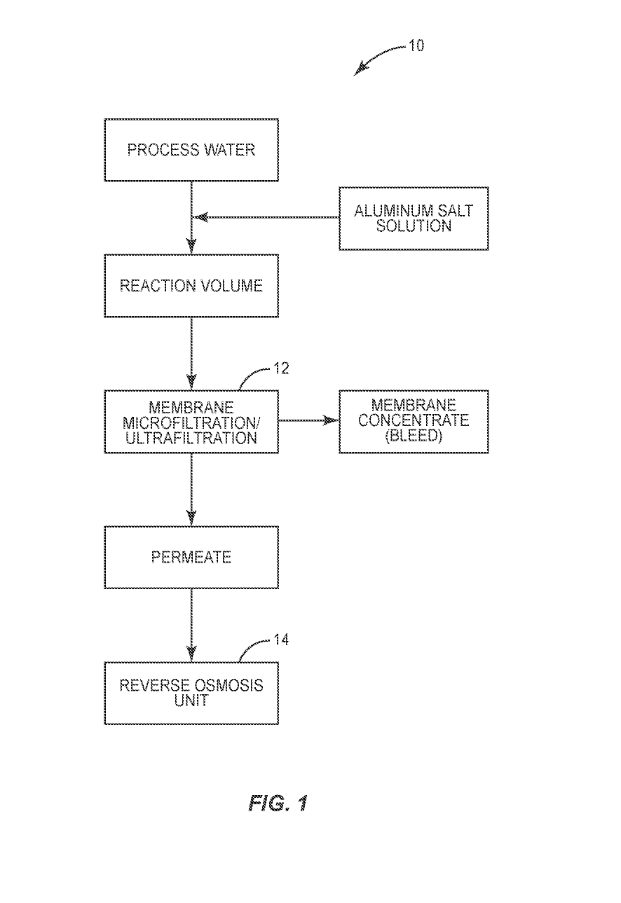

As shown in FIG. 1, an aluminum salt is added as a coagulant and is stirred and mixed in a pipe or reactor (reaction volume). In one example, the addition of an aluminum salt coagulant to the wastewater adds approximately 8 ppm of dissolved aluminum to the wastewater. While this is important for the purpose of removing solids from the wastewater, this relatively high aluminum concentration in the wastewater is a problem if it remains in the wastewater downstream of the membrane separation unit 12 and enters the reverse osmosis unit 14. This is because significant aluminum concentrations will foul and damage the membranes of the reverse osmosis unit 14. Thus, the process of the present invention removes aluminum from the wastewater prior to entry into the reverse osmosis unit 14. It should be noted that some wastewater will contain significant concentrations of aluminum, concentrations above 0.1 ppm. The present process is also applicable to these wastewaters.

Therefore, the concern in the case of the embodiments illustrated herein is with the aluminum concentration in the permeate stream from the membrane separation unit 12. In order to avoid significant aluminum fouling of the reverse osmosis unit 14, it has been determined that the aluminum concentration from the permeate stream of the membrane separation unit 12 should, in one embodiment, be less than 0.1 ppm. It has been determined that the aluminum concentration in the permeate stream of the membrane separation unit 12 can be controlled by controlling the residence time (sometimes referred to as hydraulic residence time) of the coagulated wastewater. The problem with a long residence time for the aluminum salt in the coagulated wastewater is due to the immediate dissolution of the aluminum salt which occurs with commensurate lowering of the feed or concentrate pH to a level that causes a majority of the aluminum to become immediately insoluble. This aluminum forms hydroxide precipitates/coagulants, which are captured on the ceramic membrane and thereby not released into the permeate. Over long residence times, i.e., in some cases greater than 20 to 30 minutes, for example, the pH of the feed or concentrate rises due to on-going hydration reactions and this elevation in pH causes some of the captured insoluble aluminum to again become soluble, such that it is released into the permeate. In one embodiment, no pH modifying additive is used in conjunction with the coagulant. That is, the process does not use a pH adjusting chemical treatment to reduce the concentration of aluminum in the permeate to the reverse osmosis unit 14.

The present invention entails a system and process for controlling the hydraulic retention time of the coagulated feedwater. Moreover, the present invention entails a system and process for treating a feedwater stream (the term “feedwater” and “wastewater” are used interchangeably herein) having a significant aluminum concentration in excess of 0.1 ppm. Wastewater is treated by mixing an aluminum salt coagulant with the wastewater. The wastewater stream is then directed to a microfiltration or ultrafiltration membrane separation unit which produces a permeate stream and a reject or concentrate stream. The permeate stream is directed to a reverse osmosis membrane unit which filters the permeate stream to produce an RO permeate stream and an RO reject stream. In one embodiment, the present invention entails controlling the hydraulic residence time of the coagulated feedwater so as to control the aluminum concentration in the permeate stream from the microfiltration or ultrafiltration membrane separation unit to less than 0.1 ppm.

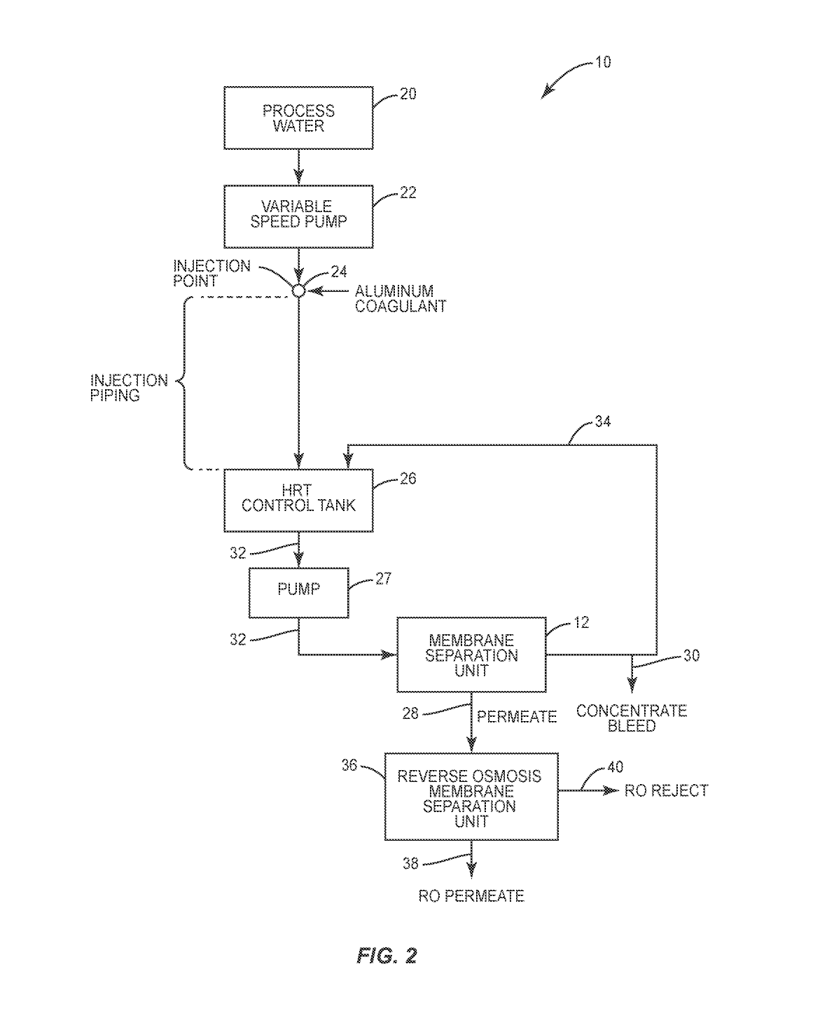

With reference to FIG. 2, another embodiment of the present invention is shown. Process water or wastewater (block 20) being treated is pumped by variable speed pump 22 to a coagulate injection point 24. At the coagulate injection point, in one embodiment, an aluminum salt coagulant such as alum is mixed with the wastewater. The alum can be injected into a pipe and mixed in the pipe or the injection point 24 can comprise a tank having a mixer therein. Once the alum is added to the wastewater, the wastewater is pumped to an HRT control tank 26. Note that the pipe or line extending from the injection point 24 to the tank 26 is referred to as injection piping. Wastewater in the HRT control tank 26 is pumped by a pump 27 to the membrane separation unit 12. Pump 27 is operative to provide a generally constant flow of wastewater from the HRT control tank 26 to the membrane separation unit 12. As noted above, the membrane separation unit 12 may include a microfiltration separation unit or an ultrafiltration separation unit, for example. In addition, one particular type of membrane separation unit that can be used is a ceramic membrane. Membrane separation unit 12 produces a permeate 28 and a concentrate. A portion of the concentrate is bled off and forms a concentrate bleed 30. The remaining portion of the concentrate is recycled to the HRT control tank 26. There is effectively formed a concentrate loop or line that extends from the HRT control tank 26 to the membrane separation unit 12 and back to the HRT control tank. The concentrate loop lines are referred to in FIG. 2 as lines 32 and 34. Therefore, at any time the coagulated wastewater is that wastewater in the injection piping, HRT control tank 26, lines 32 and 34, pump 27, and the membrane separation unit 12.

Downstream from the membrane separation unit 12 is a reverse osmosis membrane separation unit 36. Reverse osmosis membrane separation unit 36 produces an RO permeate 38 and an RO reject 40.

As discussed above, the present invention entails a process that aims at controlling the dissolved aluminum concentration in the permeate 28 emitted by the membrane separation unit 12. Again, the purpose of controlling the aluminum concentration in the permeate 28 is to prevent the aluminum from fouling the reverse osmosis membranes. Thus, there is a target aluminum concentration for the permeate 28. The target aluminum concentration reflects a threshold concentration that will not foul the reverse osmosis membrane but at the same time will not result in an inefficient or ineffective coagulation process. In one embodiment, the targeted or threshold concentration of aluminum in the permeate is 0.1 ppm. In this case, the HRT of the coagulated wastewater is controlled to maintain the aluminum concentration in the permeate from the membrane separation unit 12 at a concentration below 0.1 ppm. Therefore, the invention entails taking a sample of the permeate 28 and determining the aluminum concentration. If the aluminum concentration exceeds the targeted aluminum concentration, then it follows that the HRT of the coagulated wastewater should be reduced. If the aluminum concentration of the permeate is substantially less than the targeted or threshold aluminum concentration, then it follows that the HRT of the coagulated feedwater can be increased so long as the increase in the HRT does not cause the targeted aluminum concentration in the permeate to be exceeded. There may be cases where the aluminum concentration in the permeate is substantially below the targeted aluminum concentration and there is a need to increase HRT in order to enhance or improve the effectiveness of the aluminum salt coagulant.

The basic control process envisioned is a control process that controls the volume or level of wastewater contained in the HRT control tank 26. As discussed below, once the process is operating in a steady state condition, increasing the level of wastewater in the HRT control tank 26 will increase the HRT of the coagulated wastewater. Decreasing the volume or level of wastewater in the HRT control tank 26 will decrease the HRT of the coagulated feedwater.

In controlling the level of wastewater in the HRT control tank 26, it should be kept in mind that the amount of the aluminum coagulant injected into the wastewater stream should be controlled and maintained proportional to the wastewater that the coagulant is being mixed with. Therefore, as the flow to the HRT control tank 26 is varied, it is preferred that the amount of aluminum coagulant injected into the wastewater also be varied. Again, it is preferable to generally maintain a constant ratio between the wastewater and the aluminum coagulant added.

FIG. 2 is a schematic that shows the different components of the membrane concentrate loop in which aluminum salt reaction products (for example insoluble aluminum hydroxide precipitants and soluble aluminum ionic species) are mixed with process water being treated. As denoted in FIG. 2, these components include the injection piping, the HRT control tank 26 (which typically is the feed tank to the circulation pump 27 of the membrane separation unit 12), the membrane separation unit 12, pump 27, and the concentrate loop piping including pipes 32 and 34. The hydraulic residence time for the coagulated wastewater and for the aluminum salt reaction products in the membrane concentrate loop is the combined volume of the coagulated wastewater within the components comprising the injection piping, HRT control tank 26, the membrane separation unit 12, pump 27, and lines 32 and 34 divided by the combined flow rates of the permeate 28 and the concentrated bleed flow 30. For typical crossflow membrane processes running at a high recovery rate (for example greater than 95%, where the recovery factor is defined as the permeate flow rate divided by the sum of the permeate flow rate and the concentrate bleed flow rate.

For a number of these components of the membrane concentrate loop (injection piping, membrane separation unit 12, pump 27, and concentrate loop piping 32 and 34) the volume of the coagulated wastewater is invariant for a particular membrane crossflow system since these components must be fully filled or flooded with treated process water during normal process operation. However, the volume of the treated wastewater within the HRT control tank 26 can be varied to a significant and useful degree. Moreover, in a typical crossflow membrane system, the volume of the tank, as depicted in FIG. 2, will be more than an order of magnitude greater than the combined volume of the injection piping, membrane separation unit 12, pump 27, and the concentrate loop piping 32 and 34. This implies that the total volume of the membrane concentrate loop is dominated by the volume of the treated wastewater held within the HRT control tank 26. Therefore, by varying the volume or level of the wastewater in the HRT control tank 26, the HRT for the coagulated wastewater can be controlled independently of the flow rate of the permeate 28 and concentrate bleed 30. For instance, adjusting the HRT of the coagulated wastewater from one value to another value is done by temporarily increasing the flow rate of the process wastewater to the injection point 24 and increasing the aluminum coagulate injected into the piping. This will increase the flow of coagulated wastewater into the HRT control tank 26. This is carried out while simultaneously maintaining the relative flow ratios of the process water to aluminum coagulate and while maintaining the flow of the permeate 28 and concentrate bleed 30 generally constant. This will change the volume or level of the wastewater in the HRT control tank 26 and thereby set the HRT for the aluminum salt reaction products to a different, constant and controlled value, independent of membrane permeate and concentrate bleed flow rates. Once the desired volume of treated process water in the tank is achieved, the combined flow rates of the wastewater and aluminum coagulate are reset to their initial values, that is a value equal to the combined membrane permeate and concentrate bleed flows.

### Example

Process water was taken from an oil sands mining tailings pond and trucked to a laboratory for use in pilot process test trials. This water had a pH of 8.16 and contained a dissolved aluminum concentration of 0.39 ppm and a total (dissolved plus suspended) aluminum concentration of 3.5 ppm. A concentrated solution was prepared using aluminum sulfate dodecahydrate (“alum”), which was dosed with rapid stirring into the process water at a ratio that produced an added dissolved aluminum concentration of 8 ppm in the process water. The alum-dosed process water was sent as feedwater to a ceramic crossflow ultrafiltration membrane (0.1 μm pore size, titanium dioxide separation layer) and separated into a permeate stream and concentrate stream. The permeate pH, membrane concentrate pH, and dissolved aluminum concentration were monitored as a function of residence time, defined as the time interval between introduction of the concentrated alum solution into the starting process water and removal of permeate from the ceramic ultrafiltration membrane. Table I provides these values as a function of residence time in the pilot process trials. These data show that dissolved aluminum concentrations below the value of 0.1 ppm are obtained for residence times less than about 20 to 25 minutes.

TABLE I

| Residence Time | | | Al Concentration in |
|---|---|---|---|
| (min.) | Concentrate pH | Permeate pH | Permeate (mg/L) |
| Before dose | 8.16 | N/A | N/A |
| 0.33 | 7.32 | 7.64 | 0.039 |
| 0.67 | 7.30 | 7.60 | 0.027 |
| 1.08 | NM | 7.58 | 0.076 |
| 1.77 | NM | 7.59 | 0.042 |
| 2.5 | NM | 7.64 | 0.055 |
| 3 | NM | 7.59 | 0.13 |
| 3.17 | 7.34 | 7.64 | 0.035 |
| 5 | 7.36 | NM | NM |
| 6 | NM | 7.71 | 0.028 |
| 10 | 7.43 | NM | NM |
| 12 | NM | 7.79 | 0.026 |
| 15 | 7.51 | NM | NM |
| 20 | 7.56 | NM | NM |
| 30 | NM | 8.02 | 0.112 |
| 60 | NM | 8.25 | 0.231 |

Details of the ceramic membrane discussed herein are not dealt with herein because such is not per se material to the present invention, and further, ceramic membranes are known in the art. For a review of general ceramic membrane technology, one is referred to the disclosures found in U.S. Pat. Nos. 6,165,553 and 5,611,931, the contents of which are expressly incorporated herein by reference. These ceramic membranes, useful in the processes disclosed herein, can be of various types. In some cases the ceramic membrane may be of the type that produces both a permeate stream and a reject stream. On the other hand, the ceramic membranes may be of the dead head type, which only produces a permeate stream and from time-to-time the retentate is backflushed or otherwise removed from the membrane.

The structure and materials of ceramic membranes as well as the flow characteristics of ceramic membranes varies. When ceramic membranes are used to purify produced water, the ceramic membranes are designed to withstand relatively high temperatures as it is not uncommon for the produced water being filtered by the ceramic membranes to have a temperature of approximately 90° C. or higher.

Ceramic membranes normally have an asymmetrical structure composed of at least two, mostly three, different porosity levels. Indeed, before applying the active, microporous top layer, an intermediate layer is formed with a pore size between that of the support and a microfiltration separation layer. The macroporous support ensures the mechanical resistance of the filter.

Ceramic membranes are often formed into an asymmetric, multi-channel element. These elements are grouped together in housings, and these membrane modules can withstand high temperatures, extreme acidity or alkalinity and high operating pressures, making them suitable for many applications where polymeric and other inorganic membranes cannot be used. Several membrane pore sizes are available to suit specific filtration needs covering microfiltration and ultrafiltration ranges.

Ceramic membranes today run the gamut of materials (from alpha alumina to zircon). The most common membranes are made of Al, Si, Ti or Zr oxides, with Ti and Zr oxides being more stable than Al or Si oxides. In some less frequent cases, Sn or Hf are used as base elements. Each oxide has a different surface charge in solution. Other membranes can be composed of mixed oxides of two of the previous elements, or are established by some additional compounds present in minor concentration. Low fouling polymeric coatings for ceramic membranes are also available.

Ceramic membranes are typically operated in the cross flow filtration mode. This mode has the benefit of maintaining a high filtration rate for membrane filters compared with the direct flow filtration mode of conventional filters. Cross flow filtration is a continuous process in which the feed stream flows parallel (tangential) to the membrane filtration surface and generates two outgoing streams.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of treating wastewater employing a reverse osmosis membrane and reducing the tendency of the reverse osmosis membrane to foul due to the aluminum in the wastewater fed to the reverse osmosis membrane, the method comprising:
mixing an aluminum salt coagulant with the wastewater to form a coagulated wastewater and precipitating aluminum hydroxide-based precipitants from the coagulated wastewater;
after mixing the aluminum salt coagulant with the wastewater, directing the wastewater into a hydraulic residence time (HRT) control tank;
pumping the coagulated wastewater from the HRT control tank into a membrane separation unit and producing permeate and a concentrate;
recycling at least a portion of the concentrate back to the HRT control tank;
directing the permeate from the membrane separation unit to the reverse osmosis membrane and filtering the permeate to produce a reverse osmosis permeate and a reverse osmosis reject; and
controlling the aluminum concentration in the permeate to the reverse osmosis membrane to less than a targeted aluminum concentration by varying the level of coagulated wastewater in the HRT control tank.

2. The method of claim 1 including sampling the permeate from the membrane separation unit and determining the aluminum concentration in the permeate;
comparing the determined aluminum concentration with the targeted aluminum concentration; and
if the determined aluminum concentration in the permeate exceeds the targeted aluminum concentration, lowering the level of coagulated wastewater in the HRT control tank.

3. The method of claim 2 wherein lowering the coagulated wastewater in the HRT control tank includes decreasing the flow rate of coagulated feedwater directed into the HRT control tank.

4. The method of claim 1 including maintaining the permeate and concentrate flow from the membrane separation unit generally constant.

5. The method of claim 1 including bleeding a portion of the concentrate from the concentrate being recycled to the HRT control tank.

6. The method of claim 1 further including while varying the level of the coagulated wastewater in the HRT control tank, varying the amount of the aluminum salt coagulant injected into the wastewater to maintain a generally constant ratio of the aluminum salt coagulant to the wastewater.

7. The method of claim 1 further including:
after mixing the aluminum salt coagulant with the wastewater, pumping the coagulated wastewater through an injection piping to the HRT control tank; and
pumping the coagulated wastewater through a concentrate loop that includes one or more pipes operatively interconnected between the HRT control tank and the membrane separation unit.

8. The method of claim 7 wherein the HRT of the coagulated wastewater comprises the volume of the injection piping, the HRT control tank, the one or more pipes, a pump, and the membrane separation unit divided by the combined flow of the permeate and concentrate from the membrane separation unit.

9. A method of treating wastewater employing a reverse osmosis membrane and reducing the tendency of the reverse osmosis membrane to foul due to aluminum in the wastewater fed to the reverse osmosis membrane, the method comprising:
mixing an aluminum salt coagulant with the wastewater to form a coagulated wastewater and precipitating aluminum hydroxide-based precipitants from the coagulated wastewater;
after mixing the aluminum salt coagulant with the wastewater, directing the wastewater into a hydraulic residence time (HRT) control tank;
pumping the coagulated wastewater from the HRT control tank into a membrane separation unit and producing permeate and a concentrate;
recycling at least a portion of the concentrate back to the HRT control tank;
directing the permeate from the membrane separation unit to the reverse osmosis membrane and filtering the permeate to produce a reverse osmosis permeate and a reverse osmosis reject; and
controlling the hydraulic residence time of the coagulated wastewater and maintaining the aluminum concentration in the permeate from the membrane separation unit to less than 0.1 ppm by: (1) varying the level of the coagulated wastewater in the HRT control tank, and (2) while maintaining the flow rate of the permeate and the concentrate from the membrane separation unit generally constant.

10. The method of claim 1 wherein the membrane separation unit comprises a ceramic membrane.

11. The method of claim 1 wherein, other than the aluminum salt coagulant, no other pH adjustment chemical is added to the wastewater between the point of mixing the aluminum salt coagulant with the wastewater and the membrane separation unit.

12. The method of claim 1 wherein controlling the aluminum concentration in the permeate further includes:
maintaining the flow of coagulated wastewater from the HRT control tank to the membrane separation unit generally constant;
maintaining the flow of concentrate from the membrane separation unit to the HRT control tank generally constant; and
wherein there is an injection piping that leads from a point where the aluminum salt coagulant is mixed with the wastewater to the HRT control tank and the method includes varying the flow of coagulated wastewater through the injection piping to the HRT control tank.
